(19) United States
(12) Patent Application Publication
(10) Pub. No.: US 2010/0095543 A1
(43) Pub. Date: Apr. 22, 2010

(54) Tool for Installing an Electrical Outlet Box

(76) Inventor: Santana Inthavong, Arlington, TX (US)

Correspondence Address: WILSON DANIEL SWAYZE, JR., 3804 CLEARWATER CT., PLANO, TX, 75025, US

(21) Appl. No.: 12/254,849

(22) Filed: Oct. 21, 2008

(51) Int. Cl. G01B 1/00

(52) U.S. Cl. 33/528

(57) ABSTRACT

A tool for mounting at electric outlet device may include an one gang template to mount a one gang electric outlet device, and a two gang template to mount a two gang electric outlet device. The one gang template may be positioned within the two gang template. The tool may include a first leveling device, and the tool may include a second leveling device. The first leveling device and the second leveling device may be positioned within the one gang template, and the one gang template may include a substantially L-shaped slit. The two gang template may include a substantially L-shaped slit, and the tool may include a marking device holder for holding a marking device. The marking device holder may be positioned within the one gang template.

### FIELD OF THE INVENTION

This invention generally relates to a tool for placing and marking the position of an electrical outlet box. More specifically to a device and method in marking the location and support for an electrical remodel box.

### DISCUSSION OF KNOWN ART

Modern residential and commercial construction typically includes interior walls which include electrical outlets, electrical switch plates and the like mounted on these walls. In order to provide a quality appearance to the finished construction it is important to ensure that the electrical outlets, switch plates, and the like are properly positioned on the walls. The position of these outlets and switch plates is typically determined by the position of the electrical box which is covered by the outlet plate or switch plate. It is important, therefore, to ensure that the electrical box history covered by the plate is properly positioned, meaning that the electrical box is properly aligned vertically and horizontally.

There are many devices which are used for ensuring that the electrical box is properly positioned in new construction. These devices typically cooperate with structure that has been laid during construction, such as studs and floors. For example, the device taught in U.S. Pat. No. 5,630,281 to Pledger et al. includes bearing surfaces that have been adapted for placement against a stud, and surfaces for placement against the sole plate, and a protruding section that accepts the electrical box, so that the device and used to hold the electrical box at the proper location relative to the stud, and allow the user to nail or fasten the box to the stud at the proper location.

There are many tools, such as the Pledger device, which aid the user to properly position an electrical box against a stud or other structural member during construction. Often, however, it is necessary to add electrical boxes after the construction has been completed. Electrical boxes for use in applications were the construction has been completed are known as remodel boxes. A remodel box does not attach to a stud or similar structural member, but mounts against the finished wall board, and uses the wall board as a support for the box.

A remodel box typically includes an open box shaped structure which includes a generally rectangular perimeter with tabs on diagonally opposed corners. Mounted behind the tabs are pivotally mounted legs which are movable from a position where the legs are wholly contained within the perimeter of the box to a second position where the legs extend away from the perimeter to hold the box against the wall board by squeezing the wall board between the legs and the tabs.

Thus, the position of the remodel box is determined entirely by the attachment or support of the box against the wall board. Ideally, the opening in the wall board will be of a rectangular shape with sides that produce a tight fit against the perimeter of the remodel box. With a tight fit, the sides of the opening hold the box at the appropriate mounting angle. In other words, the sides of the aperture determine whether the box can tilt in a counter clockwise or clockwise manner, while the tabs and legs keep the box flush with the surface of the wall board.

U.S. Pat. No. 6,434,848 discloses a template that can be used to mark or scribe either a single gang opening or a dual gang opening for mounting an electrical box in a wall. The template is especially adapted to mark openings for “old work” boxes mounted directly to drywall. The template includes a vertical level and a horizontal level protruding from the front face of the template so that the template can be squared in either a horizontal or a vertical orientation. The levels are mounted in housings that protrude far enough to form finger grips. The openings are cut around the periphery of the template and vertical slots are provided intermediate the sides of the template to form an opening for a single gang box. A dual gang box opening can be marked primarily using the peripheral edges of the template. Rectangular protruding sections provide clearance for tabs located on “old work” boxes and one of these protrusions includes a slot for defining a portion of a dual gang box opening.

U.S. Pat. No. 6,223,445 discloses a device and method for installing and supporting an electrical remodel box from a section of gypsum board, the remodel box being of the type having a rectangular perimeter having a pair of substantially parallel sides spaced apart at a distance “w” and a pair of sides spaced apart at a distance “h”. The method involves using the device, which is a template tool which includes a base with a perimeter defined by at least one pair of substantially parallel sides, a level indicator extends between the substantially parallel sides, substantially parallel end sides between the substantially parallel sides, an upper surface and a flat lower surface, the lower surface being substantially flat. The user first locates an area on the gypsum board which is unsupported by a stud, and then places the template tool over the unsupported area. The parallel sides are then aligned the by using the level on the base. Then the user will mark the surface of the gypsum board with lines along the substantially parallel sides of the template tool and along the end sides of the base. An aperture is then cut through the gypsum board along the markings to create the edges of an aperture that is used to support the remodel box. The electrical remodel box is then inserted through the aperture in the gypsum board.

U.S. Pat. No. 6,209,214 discloses a template for permitting accurate and level marking of the shape of a wall opening for placement therein of utility boxes. The template comprises a base having a periphery shaped to match the shape of the periphery of a utility box to be fitted into the wall opening the base including opposed first and second surfaces. The first surface is adapted for being engaged with the wall to be marked. At least one spirit level cooperates with the base for permitting a user to level the template before marking the shape of the wall opening on the wall prior to forming the opening.

U.S. Pat. No. 4,793,069 discloses a tool which provides the installer of electric outlet boxes with means for outlining on a wall or similar support the contours of a one-gang box and a two-gang box including means for pre-determining height and a leveling means for placing the contours of the box on a level with the lines of a room.

### SUMMARY

A tool for mounting at electric outlet device may include an one gang template to mount a one gang electric outlet device, and a two gang template to mount a two gang electric outlet device.

The one gang template may be positioned within the two gang template.

The tool may include a first leveling device, and the tool may include a second leveling device.

The first leveling device and the second leveling device may be positioned within the one gang template, and the one gang template may include a substantially L-shaped slit.

The two gang template may include a substantially L-shaped slit, and the tool may include a marking device holder for holding a marking device.

The marking device holder may be positioned within the one gang template.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a tool of the present invention;

FIG. 2 illustrates a front side view of the tool of the present invention;

FIG. 3 illustrates a back side view of the tool of the present invention; and

FIG. 4 illustrates a side view of the tool of the present invention.

### DETAILED DESCRIPTION

This invention relates to a device for assisting an installer in properly installing utility boxes in a wall, such as drywall, floor, ceiling or door, and that the utility box is level. By “utility box” is meant any device intended to be snugly fitted into an opening in a wall. Therefore, electrical service boxes such as outlets and switches, cable television and telephone connections, plumbing fixtures such as modular clothes washer water connections, mail slots, lighting fixtures such as recessed lighting cans are among the types of utility boxes which can be installed with the device disclosed in this application.

The invention has particular application to the installation of utility boxes in existing walls, where an opening is formed in the wall and the utility box fitted into the newly-formed opening. Present techniques for making sure the opening is level include holding the utility box to be installed against the wall and tracing around the box with a pen or pencil while holding a carpenter's level on top of the box. This is difficult to do, since the top edge of some utility boxes are not regularly shaped and the level interferes with the tracing. In many cases, the installer merely “eyeballs” the correct position, resulting in irregularly-positioned utility boxes.

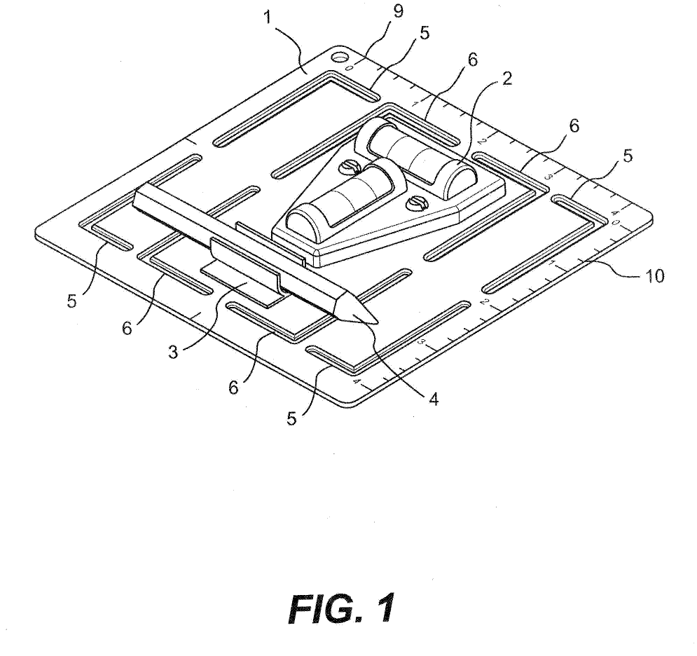

FIG. 1 illustrates a perspective view of the tool 1 of the present invention. The tool 1 may be substantially rectangular and substantially planar or other suitable shape in order to provide a combination one gauge template and a two gauge template. The one gauge template may include inner slit 6 which may be substantially L-shaped. FIG. 1 illustrates four inner slits 6 which may be positioned to define a substantial rectangle. The inner slit 6 may be sufficiently wide in order to allow a scribe, pencil or pen or other marking device to extend through the inner slit 6 in order to substantially provide an outline to be cut in drywall or other suitable material so that a single gang electrical box can be inserted.

FIG. 1 additionally illustrates a two gang template which may enclose the one gang template in order to provide an efficient footprint.

The two gauge template may include outer slit 5 which may be substantially L-shaped. FIG. 1 illustrates four outer slits 5 which may be positioned to define a substantial rectangle. The outer slit 5 may be sufficiently wide in order to allow a pencil or pen or other marking device to extend through the outer slit 5 in order to substantially provide an outline to be cut in drywall or other suitable material so that a two gang electrical box can be inserted.

A portion of the inner slit 6 may be aligned with a portion of the outer slit 5 to provide for additional outline when the two gang electrical box is being outlined.

Indicia 9 may extend along the first edge of the tool 1 in order to provide a measurement device, and indicia 10 may extend along a second edge which may be perpendicular to the first edge to provide a measurement device.

FIG. 1 illustrates a first leveling device 2 to provide an indication of level and a second leveling device 2 which may be perpendicular to the first leveling device 2 to provide an indication of level. The first leveling device 2 and the second level device 2 may be positioned within the one gauge template in order to provide an efficient footprint.

FIG. 1 illustrates a marking device 4 which may be a pen or pencil or scribe or other suitable device in order to mark the wall. The marking device 4 may be held by a marking device holder 3 which may include a pair of opposing arms to retain the marking device 4 by a friction fit.

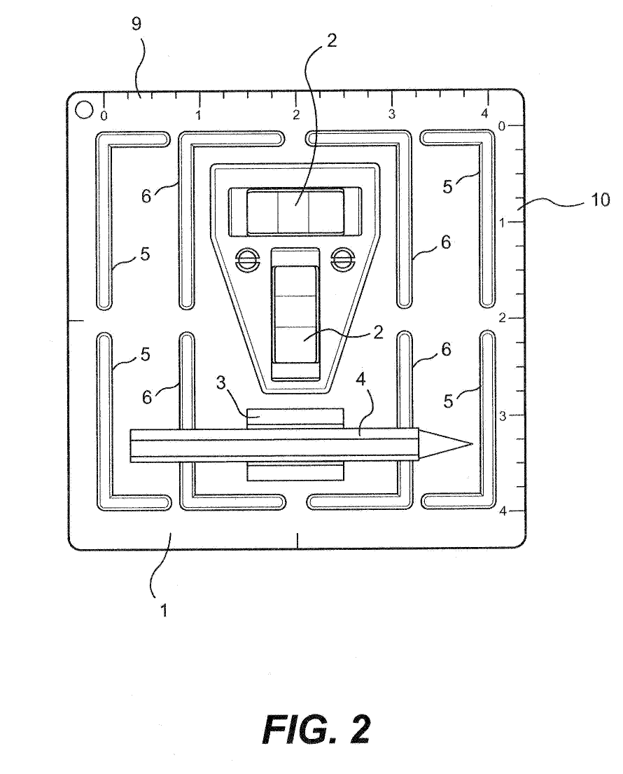

FIG. 2 illustrates a top view of the tool 1 of the present invention. The tool 1 may be substantially rectangular and substantially planar or other suitable shape in order to provide a combination one gauge template and a two gauge template. The one gauge template may include inner slit 6 which may be substantially L-shaped. FIG. 1 illustrates four inner slits 6 which may be positioned to define a substantial rectangle. The inner slit 6 may be sufficiently wide in order to allow a pencil or pen or other marking device to extend through the inner slit 6 in order to substantially provide an outline to be cut in drywall or other suitable material so that a single gang electrical box can be inserted.

FIG. 2 additionally illustrates a two gang template which may enclose the one gang template in order to provide an efficient footprint.

The two gauge template may include outer slit 5 which may be substantially L-shaped. FIG. 2 illustrates four outer slits 5 which may be positioned to define a substantial rectangle. The outer slit 5 may be sufficiently wide in order to allow a pencil or pen or other marking device to extend through the outer slit 5 in order to substantially provide an outline to be cut in drywall or other suitable material so that a two gang electrical box can be inserted.

A portion of the inner slit 6 may be aligned with a portion of the outer slit 5 to provide for additional outline when the two gang electrical box is being outlined.

Indicia 9 may extend along the first edge of the tool 1 in order to provide a measurement device, and indicia 10 may extend along a second edge which may be perpendicular to the first edge to provide a measurement device.

FIG. 2 illustrates a first leveling device 2 to provide an indication of level and a second leveling device 2 which may be perpendicular to the first leveling device 2 to provide an indication of level. The first leveling device 2 and the second leveling device 2 may be positioned within the one gauge template in order to provide an efficient footprint.

FIG. 2 illustrates a marking device 4 which may be a pen or pencil or scribe or other suitable device in order to mark the wall. The marking device 4 may be held by a marking device holder 3 which may include a pair of opposing arms to retain the marking device 4 by a friction fit.

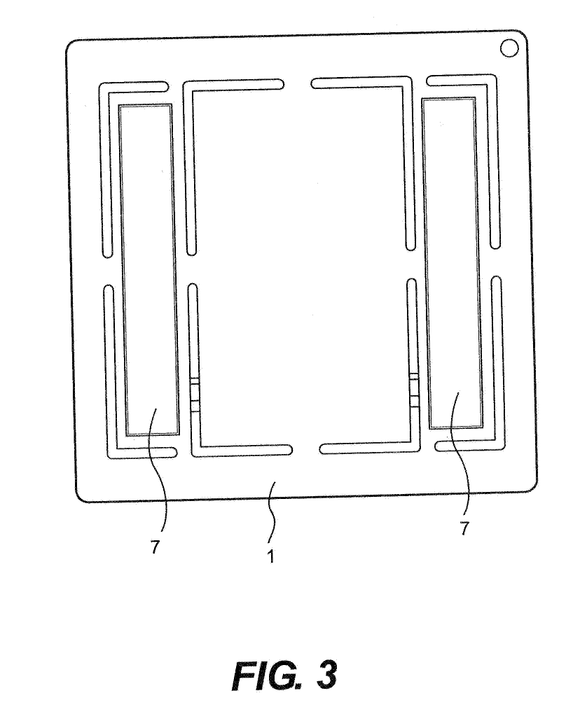

FIG. 3 illustrates the back of the tool 1 and illustrates a cushioning device 7 which may be rubber, cloth or other suitable material in order to cushion and protect the wall from scratches which could be caused by the tool 1. The cushioning device 7 may be formed between the one gang template and the two gang template.

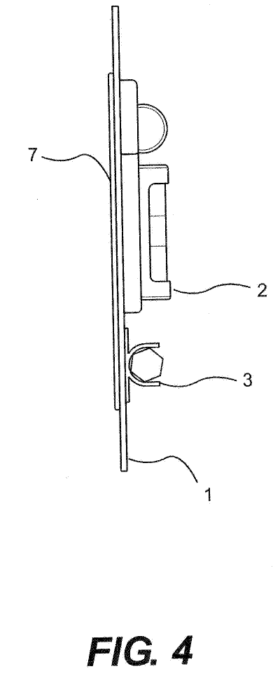

FIG. 4 illustrates the side of the tool 1 and illustrates the cushioning device 7, the leveling device 2 and the marking device 3.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A tool for mounting at electric outlet device, comprising:
an one gang template to mount a one gang electric outlet device;
a two gang template to mount a two gang electric outlet device;
wherein the one gang template is positioned within the two gang template.

2. A tool for mounting at electric outlet device as in claim 1, wherein the tool includes a first leveling device.

3. A tool for mounting at electric outlet device as in claim 2, wherein the tool includes a second leveling device.

4. A tool for mounting at electric outlet device as in claim 3, wherein the first leveling device and the second leveling device are positioned within the one gang template.

5. A tool for mounting at electric outlet device as in claim 1, wherein the one gang template includes a substantially L-shaped slit.

6. A tool for mounting at electric outlet device as in claim 1, wherein the two gang template includes a substantially L-shaped slit.

7. A tool for mounting at electric outlet device as in claim 1, wherein the tool includes a marking device holder for holding a marking device.

8. A tool for mounting at electric outlet device as in claim 7, wherein the marking device holder is positioned within the one gang template.
